(19) United States
(12) Patent Application Publication
(10) Pub. No.: US 2008/0134834 A1
(43) Pub. Date: Jun. 12, 2008

(54) Automated load shift transmission

(76) Inventors: Carsten Gitt, Stuttgart (DE); Detlef Schnitzer, Denkendorf (DE)

Correspondence Address: KLAUS J. BACH, 4407 TWIN OAKS DRIVE, MURRYSVILLE, PA, 15668, US

(21) Appl. No.: 12/008,833

(22) Filed: Jan. 14, 2008

Related U.S. Application Data
(63) Continuation-in-part of application No. PCT/EP2006/006543, filed on Jul. 5, 2006.

(30) Foreign Application Priority Data
Jul. 15, 2005 (DE) 10 2005 033 027.4

(51) Int. Cl. F16H 3/02

(52) U.S. Cl. 74/745

(57) ABSTRACT

In an automatic load shift transmission including a transmission output shaft arranged coaxially with respect to a twin clutch disposed at the transmission input side, a countershaft is provided comprising only fixed gears and all the freely movable gears and the shift elements are arranged on the shafts extending along the axis of the twin clutches and the input and output shafts.

This is a Continuation-In-Part Application of pending International Patent application PCT/EP2006/006543 filed Jul. 5, 2006 and claiming the priority of German Patent application 10 2005 033 027.4 filed Jul. 15, 2005.

### BACKGROUND OF THE INVENTION

The invention relates to an automated load shift transmission with a twin input clutch connected to concentric transmission input shafts and with a co-axial transmission output shaft.

DE 103 32 210 A1 already discloses a twin clutch trans-mission which can be used in a high-torque passenger car or a utility vehicle. This twin clutch transmission has, in a way which corresponds to the invention, a transmission output shaft which is arranged coaxially with respect to the twin clutch. The twin clutch transmission has two countershafts, which can be coupled to one another in a rotationally fixed fashion by means of a gearwheel clutch. This document also gives details on the bearing of the shafts of the twin clutch transmission.

German laid open patent application DE-A 2 325 699 also discloses a tractor transmission with a twin clutch. In this arrangement, however, only one of the individual clutches of the twin clutch has a function which is typical of a transmission. The other individual clutch of the twin clutch drives a power take off.

It is the object of the present invention to provide a cost effective utility vehicle transmission which is capable of shifting under load and which provides for low fuel consumption.

### SUMMARY OF THE INVENTION

In an automatic load shift transmission including a transmission output shaft arranged coaxially with respect to a twin clutch disposed at the transmission input side, a countershaft is provided comprising only fixed gears and all the freely movable gears and the shift elements are arranged on the shafts extending along the axis of the twin clutches and the input and output shafts.

As the transmission output shaft is arranged coaxially with respect to the twin clutch at the transmission input side, the load shift transmission can be installed in a drive train as they are customary in utility vehicles and also in high-torque passenger cars.

All the forward gears, with the exception of a direct gear which is generally present, extend along a power path through the transmission via the same countershaft. The direct gear which is present in one advantageous embodiment can be associated, in a particularly advantageous way, with a particular power path extending via the countershaft, so as to form with the direct gear a load paths for an overlap shift control by the twin clutch. This overlap control is necessary for the provision of a load shifting capability of the load shift transmission. Furthermore, in this embodiment which includes a direct gear, a group of up to four gears around the direct gear is provided with each of which sequential shifting under load is possible.

Alternatively or additionally, a first and a second input constant may be present, in which case the first power path runs via one of the input constants and the countershaft, while the further power path extends via the second input constant and the countershaft.

The input constants have different transmission ratios in order to provide for different overall transmission ratios of the load shift transmission without the need for changing the momentary gearwheel stage of the main transmission.

In the embodiment with two input constants it is therefore possible to provide a load shift capability for all the gear changes, which involve a change of the input constants. Such a change of the input constants is also referred to as split shifting. In one possible basic embodiment of the load shift transmission according to the invention, the load transmitting spur gear stage in the main transmission cannot be changed without an interruption in the tractive force. In one particularly advantageous embodiment of the invention, this problem can be eliminated in that in the load shift transmission the split shifting operations with load shifting capability are followed in the main transmission by a shifting operation without load shifting so that only every second sequentially successive shifting operation can be carried out with a load shifting capability that is without an interruption in the tractive force.

In one particularly advantageous development of the invention, this problem is taken into account by integrating the direct gear into the sequence of the forward gears in the way described below.

A first alternative embodiment provides two input constants within the split group, wherein the load shift trans-mission is embodied as an overdrive transmission. In this context, the overdrive, that is to say the transmission ratio i<1, is implemented by means of the two input constants. In the case of a 16 gear transmission this may be, for example, the 16th gear, while the 15th gear is a direct gear. Since the power paths of these two gears extends via different individual clutches of the twin clutch and accordingly via different intermediate shafts, and since the direct gear does not require a cyclical gear stage in the main transmission, shifting under load is possible between these gears.

In simplified terms, when there is one open individual clutch and one closed individual clutch the two gears can be “engaged” simultaneously in the main transmission without the transmission becoming locked.

Likewise, in the case of operation in the direct gear, for example the 15th gear, with the associated individual clutch closed, the next lower gear, for example the 14th gear, can be engaged, with the associated individual clutch still open at first, without the load shift transmission being locked. By closing the open individual clutch while simultaneously opening the closed individual clutch it is then also possible to shift between the aforesaid gears, for example 15th gear and 14th gear, without an interruption in the tractive force.

The split shifting, for example from the 14th to the 13th gear, which follows during down-shifting, can also be carried out with a load shifting capability in accordance with the principle explained above.

The above described arrangement results in a particularly advantageous embodiment of a load shift transmission which, in addition to the split shifting operations with which load shifting can be performed in any case, has a gear group of a total of four gears which follow one another successively and with which load shifting can be performed sequentially in any desired direction, i.e. “shifting up” and “shifting down”. In this context, the split shifted operations with a load shifting capability are defined by means of in each case two successive gears which have the same shifted state in the main group, but not in the split group.

In the case of a load shift transmission which, in addition to the split group, also has a range group, the above-described effect of the four gears with which load shifting can be performed sequentially can in principle be used twice, specifically in each of the two shifted states of the range group, which is also referred to as a range transmission. In one advantageous embodiment, a crawler gear may be provided, which cannot be combined with all the shifted states of the range group.

In a transmission with more than two input constants within the split group, for example an 18 speed transmission with three input constants in the split group, the upper gears can be conceived in such a way that the highest gear and the third highest gear are implemented by means of a combination of the input constants, while the second highest gear is the direct gear. The torque flow for the highest gear can extend herein from the first input constant via the second input constant, while the torque flow for the third highest gear extends from the first input constant via the third input constant. Load shifting can then also be performed with these three gears.

In addition, in the case of the 18 gear transmission, load shifting can also be carried out sequentially with all the split shifting operations so that in the embodiment illustrated in the table in FIG. 13 gear groups of in each case three adjacent gears are formed with which load shifting can be sequentially performed.

It is particularly advantageous if, the shift elements or shift sleeves are arranged in such a way that they extend exclusively coaxially with respect to the transmission input shaft and transmission output shaft. In this case, the actuation system for activating the shift sleeves can be made particularly compact and cost effective. In this context it is possible to provide a countershaft which is then fitted exclusively with fixed gears. The exclusive use of a countershaft has advantages in terms of cost, weight and installation space, and these advantages counter-balance the disadvantage of a high degree of bending of the shaft and high displacement forces since the gear teeth which transmit the torque tend to force the two parallel spaced shafts apart. This high degree of bending of the shafts can be prevented, for example, by supporting the intermediate shaft and the transmission output shaft by additional bearings as it is described for example in DE 10332210.8-23. A further advantageous possible way of preventing high degrees of bending of the shaft and bearing stresses is to use two countershafts which are at least partially of identical design and whose forces cancel one another out. In this case, the two countershafts can also be provided exclusively with fixed wheels and/or not be fitted with shift sleeves. As a result, both, bearings according to DE 10332210.8-23 and the use of two countershafts, permit axially short transmissions.

Utility vehicle transmissions, in particular for heavy duty vehicle applications, such as for example long-distance transportation, have a large number of gears with, at the same time, small gear increments compared to passenger cars, wherein a gear increment is defined as the ratio between the transmission ratios of two adjacent gears. Small gear increments are advantageous insofar as the operating state of the drive motor can be adapted with “fine graduation” to the power demand or torque demand of the respective driving situation. This is advantageous in particular if the drive motor has a small excess power in wide ranges of the driving mode so that, for example, shifting down is already necessary, for example, when there is an imminent slight positive gradient. Such “fine graduation” of the configuration of the transmission is also advantageous when the drive engine is to be operated at any time in an operating state with the lowest possible specific consumption of fuel.

It is particularly advantageous if load-shifting is possible for just one specific, appropriately selected, portion of the gear changes. As a result, depending on the use of the vehicle, those gear changes which would be considered to be uncomfortable or disadvantageous in some other way if there were an interruption in the traction force are provided with a load shifting capability. In contrast, those gear stages where a load-shifting capability would merely or predominantly make the load shift transmission more expensive, heavier and/or larger are not provided with a load shifting capability.

For example, in the case of long-distance transportation vehicles it may be sufficient if it is possible to shift solely between the highest forward gears without an interruption in the tractive force. In contrast, in other vehicle applications it may be more advantageous if, in particular, the lower gears have a load shifting capability. These applications are, in particular, vehicles with frequent starting processes such as, for example, town buses, garbage trucks or vehicles with frequent starting processes on rough terrain or with very high utilization rate of the vehicle, for example heavy-duty use on construction sites. In this context, the load shifting capability can also be extended to the reverse gears.

The load shifting capability can therefore be implemented by virtue of the fact that in the case of a vehicle transmission with a split group the two input constants are each coupled to a separate individual clutch of the twin clutch in a rotationally fixed fashion, if appropriate by means of a torsion damper. The intermediate shaft of the one input transmission ratio is then embodied as a hollow shaft, while the other is embodied as an internal shaft which extends through the latter. In this context, one of the input constants can be continuously connected via a fixed wheel to one of the individual clutches of the twin clutch, whereas the other input constant can be separated from the other individual clutch by means of a shifting element.

In an advantageous embodiment of the load shift transmission, the load shifting capability of the four forward gears V13-V16 is used only in one shift state of the range group. In this context, the load shift transmission can be embodied, for example, as a 16 gear transmission, with the following “gear groups” being formed, within whose boundaries a load shifting capability is provided:

first and second forward gear,

second to fourth forward gear,

fifth to eighth forward gear,

ninth and tenth forward gear,

eleventh and twelfth forward gear,

thirteenth to sixteenth forward gear.

### This results basically in respective groups of 2 or 4 gears with load shifting capability.

However, for the driver it could be uncomfortable if it is possible to travel with load shifting from the fifth forward gear to the eighth forward gear, while in the following higher gears an interruption in the tractive force occurs in turn every two gears

between the tenth and eleventh forward gear and

between the twelfth and thirteenth forward gear. However, the effect of the shifting without an interruption in the tractive force is significant for utility vehicles, in particular in the top forward gears—freeway driving, thirteenth to sixteenth forward gear. Accordingly, it is possible to provide according to the invention that a shifting operation with interruption of the tractive force is provided between the sixth and seventh forward gears even though load-shifting would be technically be possible in terms of the transmission design. However, the driver then has a “uniform shifting feel” in the lower gears. This prevention of load shifting of load-shiftable gears is controlled however by a transmission control unit.

In one particularly advantageous embodiment of the invention, when the direct gear is engaged the countershaft can be decoupled rotationally from the rotational movement of a drive engine, as it is possible, for example, in DE 102005020606.9 which was not published before the priority date of the present document. In this context, one of the individual clutches of the twin clutch can be used to decouple the countershaft. In this embodiment it is also possible to provide two countershafts which divide the power path in order to minimize the loading on the bearings of the load shift transmission.

The invention will become more readily apparent from the followed description of exemplary embodiments on the basis of the accompanying drawings:

### BRIEF DESCRIPTION OF THE DRAWINGS

FIG. 1 shows a load shift transmission with two trans-mission ratios within a split group, only one countershaft, embodied as a 16 gear transmission with an overdrive gear, with the power path in the thirteenth forward gear being indicated,

FIG. 2 shows the load shift transmission shown in FIG. 1, wherein the divided power path is represented for the overlapping shifting operation from the thirteenth forward gear into the fourteenth forward gear,

FIG. 3 shows the load shift transmission shown in FIG. 1, with the power path in the fourteenth forward gear being indicated,

FIG. 4 shows the load shift transmission as shown in FIG. 1, with the divided power path being represented for the overlapping shift operation from the fourteenth forward gear into the fifteenth forward gear,

FIG. 5 shows the load shift transmission as shown in FIG. 1, with the power path in the fifteenth forward gear which forms the direct gear being indicated,

FIG. 6 shows the load shift transmission as shown in FIG. 1, with the divided power path for the overlapping shifting from the fifteenth forward gear into the sixteenth forward gear being indicated,

FIG. 7 shows the load shift transmission as shown in FIG. 1, with the power path in the sixteenth forward gear being indicated,

FIG. 8 shows a table with the shift states for the load shift transmission illustrated in FIGS. 1 to 7, with two input constants with different transmission ratios within the split group, in the form of a 16 gear transmission with an overdrive gear,

FIG. 9 shows a load shift transmission with two input constants with different transmission ratios within a split group, in the form of a 16 gear transmission with two crawler gears,

FIG. 10 shows a table with the shift states for the load shift transmission illustrated in FIG. 9 with two crawler gears,

FIG. 11 shows a load shift transmission with two trans-mission ratios within a split group, just one countershaft, in the form of an 8 gear transmission,

FIG. 12 shows a table with the shift states for the load shift transmission illustrated in FIG. 11, which is in the form of an 8 gear transmission,

FIG. 13a to 13d show a load shift transmission with three transmission ratios within a split group, just one countershaft, in the form of an 18 gear transmission,

FIG. 13e shows a table with the shift states for the load shift transmission according to FIG. 13a to 13d,

FIG. 14 shows a load shift transmission with two countershafts which are associated with the same component transmission and are both provided exclusively with fixed wheels, and

FIG. 15 shows a load shift transmission in the form of a 16 gear transmission with two overdrive gears.

### DESCRIPTION OF THE VARIOUS EMBODIMENTS

FIGS. 1 to 7 show a load shift transmission which has, on the input side, a dry twin clutch 1 which is embodied as a friction clutch. A primary mass 2 of this twin clutch 1 is connected via a torsion damper to a crankshaft of a drive engine. In the text which follows, the direction pointing axially toward the drive engine is referred to as “front”, while the direction pointing axially toward a transmission output flange 7 is referred to as “rear”. This corresponds to the installation direction for vehicles with rear drive and a front engine, as they are generally used in high-torque passenger cars and utility vehicles. The primary mass 2 can alternatively be coupled in a frictionally locking fashion to two clutch plates 3, 4, the first clutch plate 3 of which is associated with a first individual clutch K1, while the second clutch plate 4 of which is associated with a second individual clutch K2. By means of the second individual clutch K2 it is possible to transmit the torque to an intermediate shaft which is embodied as an internal shaft 5 and which extends within a hollow shaft 6. This hollow shaft 6 also forms a second intermediate shaft and is connected to the clutch plate 3 of the first individual clutch K1.

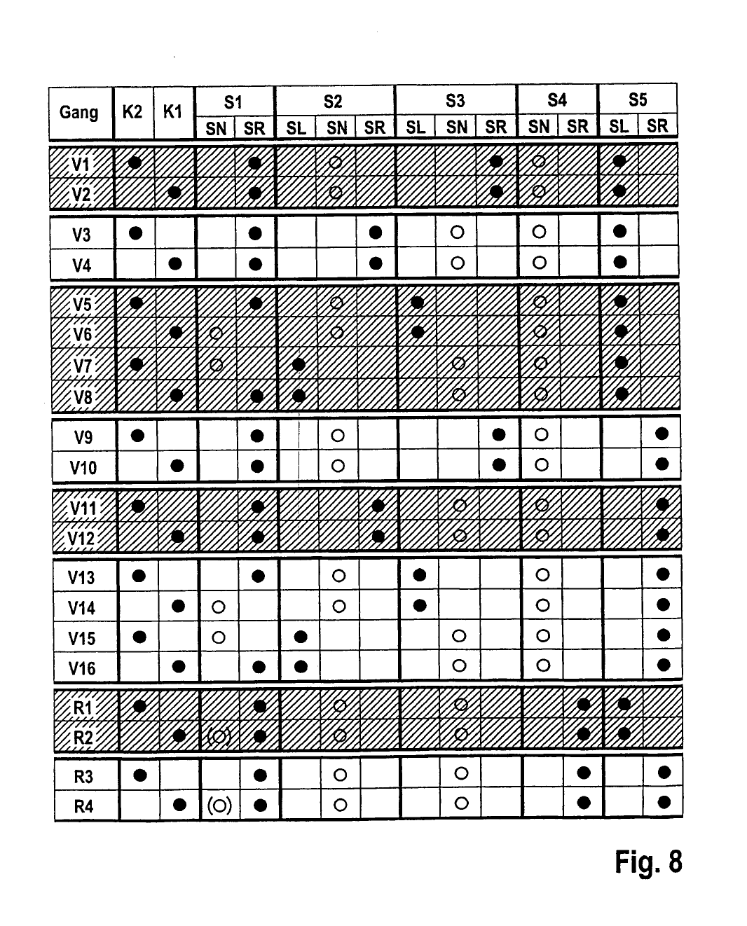

The hollow shaft 6 is connected in a rotationally fixed fashion at its right end to a fixed wheel 8 which forms the individual gearwheel of a first input constant E1. In contrast, the internal shaft 5, which extends through the hollow shaft 6, carries, in succession, a synchronizing element, a shift toothing and a freely moving wheel 9 which is coupled to the shift toothing in a rotationally fixed fashion. This freely moving wheel 9 forms the input gearwheel of a second input constant E2. The shift sleeve is rotationally fixed and axially displaceable with respect to the synchronizing element so that the freely moving wheel 9 can be coupled to the internal shaft 5 in a rotationally fixed fashion. The synchronizing element, the shift sleeve and the shift toothing therefore form a shift element S1 which can be displaced into a neutral position SN or, as an alternative to the aforesaid rotationally fixed coupling, into a right-hand position SR, as can be seen in the table in FIG. 8.

The two input constants E1 and E2 form together a split group 98.

A main shaft 10 is arranged coaxially that is, in alignment with the internal shaft 5 and with respect to the hollow shaft 6. The main shaft 10 has roller bearings here at its front end, between it and the internal shaft 5 in a way which is not illustrated in more detail. At this end, the main shaft 10 is fitted with a second shift element S2 which can be displaced into the three positions SL, SN, SR. In the foremost position SL, the second shift element S2 establishes a rotationally fixed connection between the main shaft 10 and the internal shaft 5, with the result that the direct gear is engaged. The neutral position SN is located centrally in the case of the shifting element S2. In the rearmost position SR, the shift element S2 establishes a rotationally fixed connection between the main shaft 10 and the first freely moving wheel 12 of a main group 11. This first freely moving wheel 12 meshes with a fixed wheel 13, which is arranged in a rotationally fixed fashion on a countershaft 14. The first gearwheel stage 15 of the main group 11 is thus formed from the first freely moving wheel 12 and the first fixed wheel 13. The second gearwheel stage 16 and the third gearwheel stage 17 follow behind. Their fixed wheels 18, 19 are arranged on the countershaft 14, while their freely moving wheels 20, 21 are arranged on the main shaft 10. The third shift element S3 is arranged between these two freely moving wheels 20, 21 so that in the front position SL it establishes a rotationally fixed connection between the main shaft 10 and the freely moving wheel 20, and in the rear position SR it establishes a rotationally fixed connection between the main shaft 10 and the freely moving wheel 21. In the central position SN the third shift element S3 is in the neutral position.

Next is the gearwheel stage 22, assigned to the reverse gear, of the main group 11. This gearwheel stage 22 is assigned a fixed wheel 25 which is arranged on the countershaft 14 in a rotationally fixed fashion and a freely moving wheel 24 which is rotatably arranged on the main shaft 10. An intermediate gearwheel 23 which is rotatably arranged on an axle 26 intermeshes, on the one hand, with the fixed wheel 25 and, on the other hand, with the freely moving wheel 24 of the gearwheel stage 22 which is assigned to the reverse gear. For the sake of clarity, the shaft 26, which is arranged in a plane different from that of the main shaft 10 and the countershaft 14, is represented in the same plane so that only the intermeshing engagement with the fixed wheel 25 can be seen. The fourth shift element S4 is arranged between the freely moving wheel 24 and the adjacent freely moving wheel 21 of the third gearwheel stage 17. This fourth shift element S4 can, on the one hand, be displaced into a neutral position SN. On the other hand, the fourth shift element S4 can be displaced into a position SR in which it establishes a rotationally fixed connection between the main shaft 10 and the freely moving wheel 24.

The rearmost end of the main shaft 10 is connected to a sun wheel 27 which forms the input element of a range group 28 which is embodied as a planetary gear mechanism. A planetary carrier 31 which is fitted with a plurality of planets 30 is connected in a rotationally fixed fashion to the transmission output shaft 29 and the transmission output flange 7. The transmission output shaft 29 projects here through a support wall 32 for supporting the bearings. Likewise, an internal gearwheel carrier shaft 33 projects through the support wall 32. On the transmission output side of the support wall 32, a fifth shift element S5 is arranged, by means of which shift element S5 the internal gearwheel carrier shaft 33 can optionally be connected in one position SL to the support wall 32 which is fixed to the transmission housing, and in one position SR to the trans-mission output shaft 29. The fifth shift element S5 also has a central neutral position SN.

FIG. 1 shows, in conjunction with the table in FIG. 8, that the thirteenth forward gear V13 is engaged in this load shift transmission if
the second individual clutch K2 is engaged in a frictionally locking fashion,
the first shift element is in the rear position SR,
the second shift element S2 is in the central neutral position SN,
the third shift element S3 is in the front position SL,
the fourth shift element S4 is in the left-hand neutral position SN, and
the fifth shift element S5 is in the rear position SR.
   In this case, the freely moving wheel 9 of the second input constant E2 and the freely moving wheel 20 of the second gearwheel stage 16 of the main group 11 are connected to the respectively associated shaft—i.e. the internal shaft 5 or the main shaft 10.

The power path extends in this case to the transmission output flange 7 via the second individual clutch K2, the second input constant E2, the countershaft 14, the second gearwheel stage 16 in the main group 11, the main shaft 10, the range group 28 which rotates as a block and the trans-mission output shaft 29. In this way, the power path extends without branching from the transmission input shaft 34 to the transmission output shaft 29.

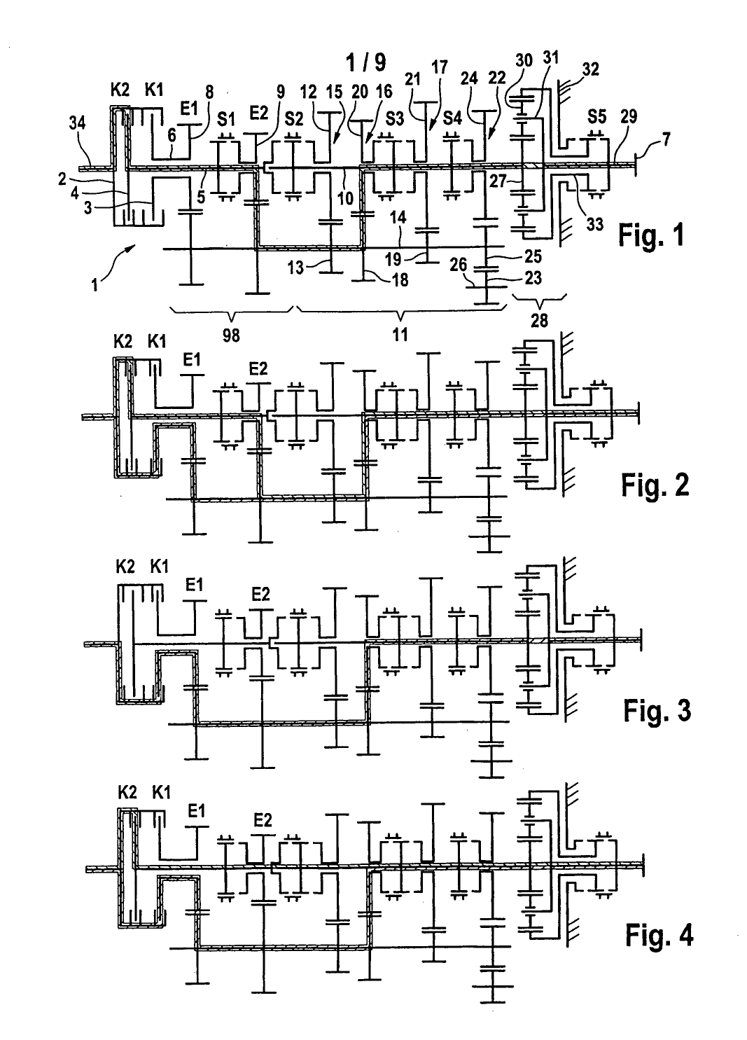

For the purpose of a gear change or shifting up operation from the thirteenth forward gear V13 into the fourteenth forward gear V14 without interruption in the tractive force it is firstly necessary to carry out an overlap control operation at the twin clutch 1 with the inclusion of two power paths according to FIG. 2. For this purpose, there is no change of position at the shift elements S1 to S5. The first individual clutch K1 is merely closed in an overlap control operation, while the second individual clutch K2 is opened. While a proportion of the transmission input power which decreases over the shifting time runs via the aforesaid power path of the thirteenth forward gear V13 which is illustrated in FIG. 1, a proportion of the trans-mission input power which increases over the shifting time runs via the power path of the fourteenth forward gear V14. This power path of the fourteenth forward gear V14 can be seen separately in FIG. 3 and it runs to the transmission output flange 7 via the first individual clutch K1, the first input constant E1, the countershaft 14, the second gearwheel stage 16 in the main group 11, the main shaft 10, the range group 28 which rotates as a block, and the trans-mission output shaft 29. The proportion of the power path of the fourteenth forward gear V14 which lies after the input constant E2 runs in a way which is identical to the power path of the thirteenth forward gear V13.

FIG. 3 shows the power path solely via the fourteenth forward gear V14.

For the purpose of a gear change or shifting up operation from the fourteenth forward gear V14 into the fifteenth forward gear V15 without interruption in the tractive force it is firstly necessary for an overlap control operation to be carried out on the twin clutch 1 with the inclusion of two power paths according to FIG. 4. In order to initiate the shifting operation, the second shift element S2 is firstly moved to the front position SL so that the direct gear is now engaged instead of the previously engaged “neutral position”.

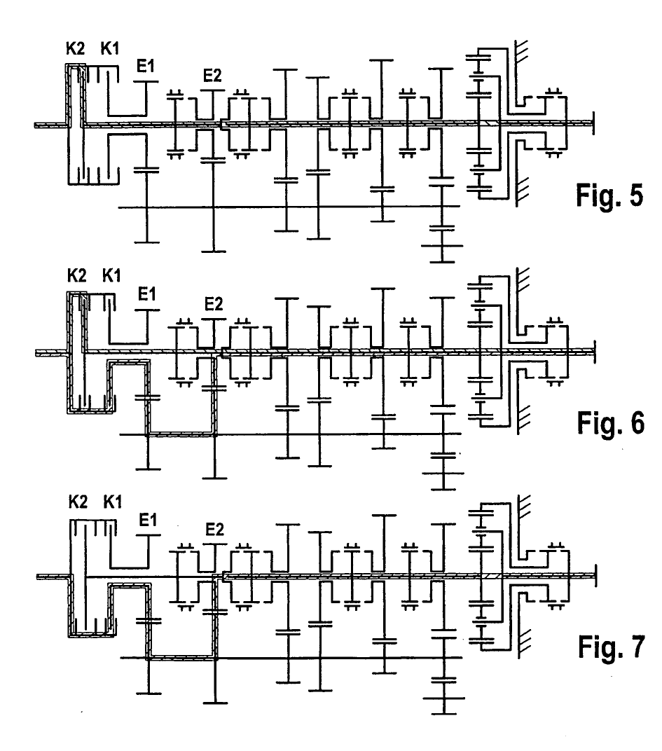

Consequently, a rotationally fixed connection is formed between the internal shaft 5 and the main shaft 10. Otherwise there is no further change of position at the other shift elements S1, S3, S4, S5. Then the second individual clutch K2 is closed in one overlap control operation, while the first individual clutch K1 is opened. While a portion of the transmission input power which decreases over the shifting time is transmitted via the power path of the fourteenth forward gear V14 which is illustrated in FIG. 3, a portion of the transmission input power which increases over the shifting time is transmitted via the power path of the fifteenth forward gear V15. This power path, which forms a direct gear, of the fifteenth forward gear V15 can be seen separately in FIG. 5 and it extends to the transmission output flange 7 via the second individual clutch K2, the internal shaft 5, the main shaft 10, the range group 28 which rotates as a block, and the transmission output shaft 29. The power path for the fifteenth forward gear V15 therefore does not extend via the countershaft 14.

FIG. 5 therefore shows the direct power path for the fifteenth forward gear V15.

For the purpose of a gear change or shifting up operation from the fifteenth forward gear V15 into the sixteenth forward gear V16 without an interruption in the tractive force it is firstly necessary to carry out an overlap control operation at the twin clutch 1 with the inclusion of two power paths according to FIG. 6. In order to initiate the shifting operation, the first shift element S1 is firstly moved to the rear position SR so that, instead of the previously held “neutral position”, a rotationally fixed connection is now provided between the internal shaft 5 and the freely moving wheel 9 of the second input constant E2. Otherwise, no further change occurs in the position at the other shift elements S2 to S5. Then the first individual clutch K1 is closed in an overlap control operation, while the second individual clutch K2 is opened. While a portion of the transmission input power which decreases over the shifting time is transmitted via the power path of the fifteenth forward gear V15 which is illustrated in FIG. 5, a portion of the transmission input power which increases over the shifting time is transmitted via the power path of the sixteenth forward gear V16. This power path of the sixteenth forward gear V16 can be seen separately in FIG. 7 and it extends to the transmission output flange 7 via the first individual clutch K1, the hollow shaft 6, the first input constant E1, the countershaft 14, the second input constant E2, the main shaft 10, the range group 28 which rotates as a block, and the transmission output shaft 29.

FIG. 7 therefore shows the power path for the sixteenth forward gear V16, which at the same time forms the highest gear of this load shift transmission.

The other gears are shifted in a way which is analogous to that in the table in FIG. 8. The forward gears V1 to V16 are illustrated successively in the rows. Following these, the reverse gears R1 to R4 are illustrated in the rows. The non-hatched rows represent first gear groups of forward and reverse gears V1, V2 and V5, V6, V7, V8 and V11, V12 and R1, R2 on which load shifting can be performed sequentially. The hatched rows represent second gear groups of forward and reverse gears V3, V4 and V9, V10 and V13, V14, V15, V16 and R3, R4 on which load shifting can be performed sequentially. The gear groups are arranged alternately here so that a first gear group is followed by a second gear group, which is in turn followed by a first gear group. Between two different gear groups, i.e. between a first and a second gear group or between a second gear group and a first gear group, there is no sequential load shifting capability. The shifted states of the second individual clutch K2, of the first individual clutch K1, of the first shift element S1, of the second shift element S2, of the second shift element S3, of the fourth shift element S4 and of the fifth shift element S5 are represented successively in the columns. What position and in which gear each of the shift elements S1 to S5 is engaged is represented in separate columns, from which the number of possible positions per shift element is also apparent.

When the direct gear is engaged, here the fifteenth forward gear V15, the first individual clutch K1 is opened. The countershaft is therefore rotationally decoupled from the rotational movement of the drive engine. Such decoupling is illustrated for transmissions without twin clutch in DE 102005020606.9, which was not published before the priority date of the present document.

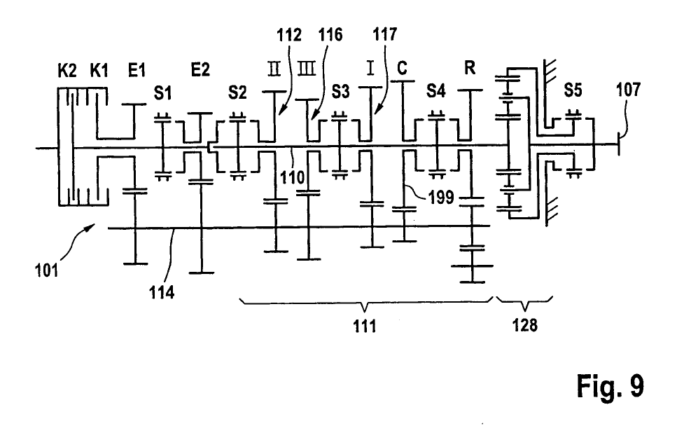

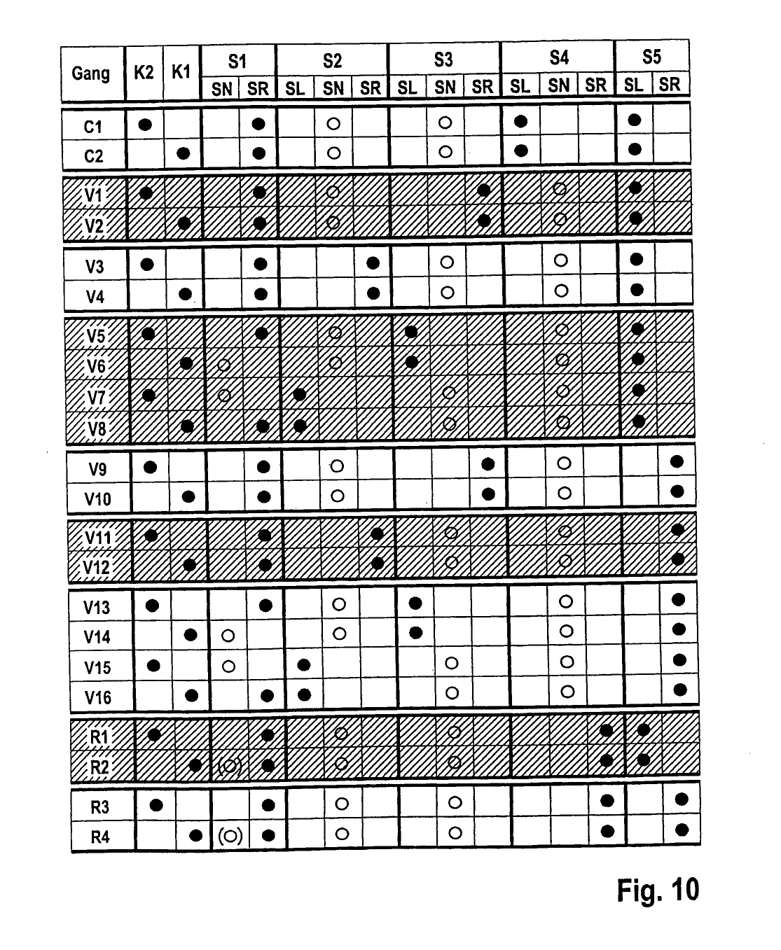

FIG. 9 shows, in a further embodiment, a load shift transmission with two input constants E1 and E2 with different transmission ratios within a split group and just one countershaft. The load shift transmission is embodied as a sixteen gear transmission with two crawler gears C1 and C2, the shift states of which can be seen in the table in FIG. 10. Such crawler gears are also referred to as “crawlers”. The load shift transmission differs from the load shift transmission according to FIGS. 1 to 7 as a result of the fact that the main group 111 has an additional gearwheel plane C which is arranged in the power path of the two crawler gears C1 and C2. Otherwise, the load shift transmission is conceptually of an identical design to the load shift transmission according to FIGS. 1 to 7; even the size ratios of the gearwheels, and thus the transmission ratios, are identical. The only exception is the gearwheel plane C which has the largest transmission ratio, with the result that the freely moving wheel 199 which is arranged coaxially on the main shaft 110 is the largest freely moving wheel, and it is arranged in the main group 111 on the main shaft 110. Below, the correspondences with the exemplary embodiment according to FIGS. 1 to 7 are explained. The input constant E1 has a smaller transmission ratio than the input constant E2. The gearwheel plane 117 which is adjacent to the crawler gear C in the main group 111 forms the next lowest transmission ratio I following the gearwheel plane C. The next lowest transmission ratio II following the latter is formed by the gearwheel plane 112 located at the front end of the main shaft 110. The next lowest transmission ratio III following the latter is formed by the gearwheel plane 116 lying centrally between the gearwheel planes 112 and 117. In the abovementioned comparisons, the transmission ratio R of the reverse gear was not taken into account. Its transmission ratio is, in terms of absolute value, approximately the transmission ratio of the gearwheel plane 117.

The table in FIG. 10 differs from the preceding table with regard to the two crawler gears C1 and C2 which are presented in the first two rows. As a result of a simple overlap control operation of the individual clutches of K2 to K1, or vice versa, a load-shifting capability is ensured between the two crawler gears. It is not necessary to change the shift elements S1 to S5. In both crawler gears C1 and C2 the first shift element S1 is therefore in the rear position SR, the second and third shift elements S2, S3 are in the neutral position SN, the fourth shift element S4 is in the front position SL, and the fifth shift element S5 is in the front position SL. The power path in the first crawler gear C1 extends from the second individual clutch K2 of the twin clutch 101 to the connection flange 107 via the second input constant E2, the countershaft 114, the gearwheel plane C, the main shaft 110 and the range group 128 which acts as a reduction gear. The power path in the second crawler gear C2 extends from the first individual clutch K1 of the twin clutch 101 to the connection flange 107 via the first input constant E1, the countershaft 114, the gearwheel plane C, the main shaft 110 and the range group 128 which acts as a reduction gear.

The crawler gear cannot be engaged by a controller for automating the load shift transmission if the fifth shift element is in the rear position SR so that the planetary gear mechanism of the range group 128 would rotate as a block.

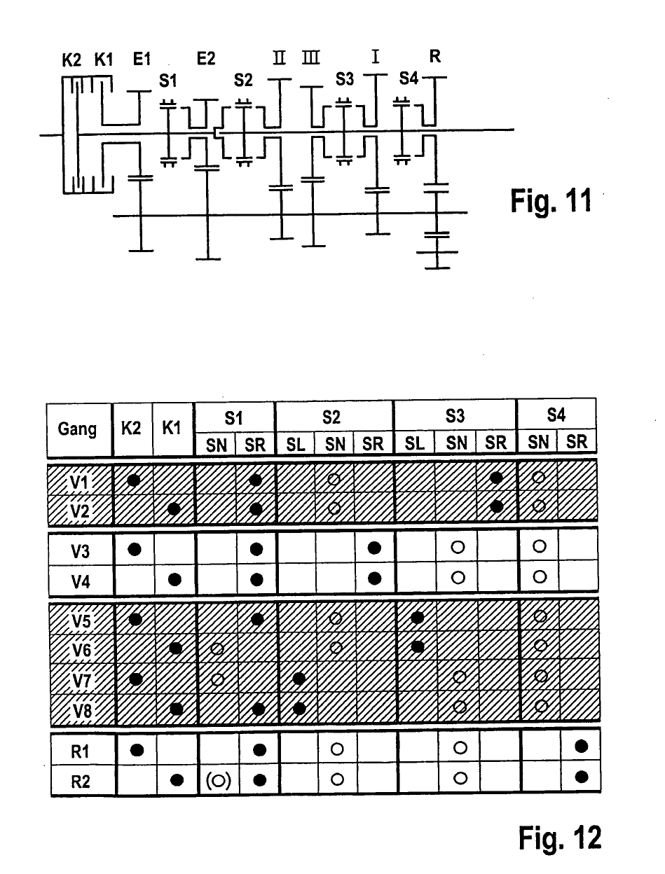

FIG. 11 shows a load shift transmission with two input constants E1 and E2 with different transmission ratios within a split group, with just one countershaft, forming an 8 gear transmission. The only difference from the exemplary embodiment according to FIGS. 1 to 7 is the fact that a range group is dispensed with. Such a transmission is appropriate in particular for lightweight utility vehicles and passenger cars.

FIG. 12 shows a table with the shift states for the load shift transmission represented in FIG. 11.

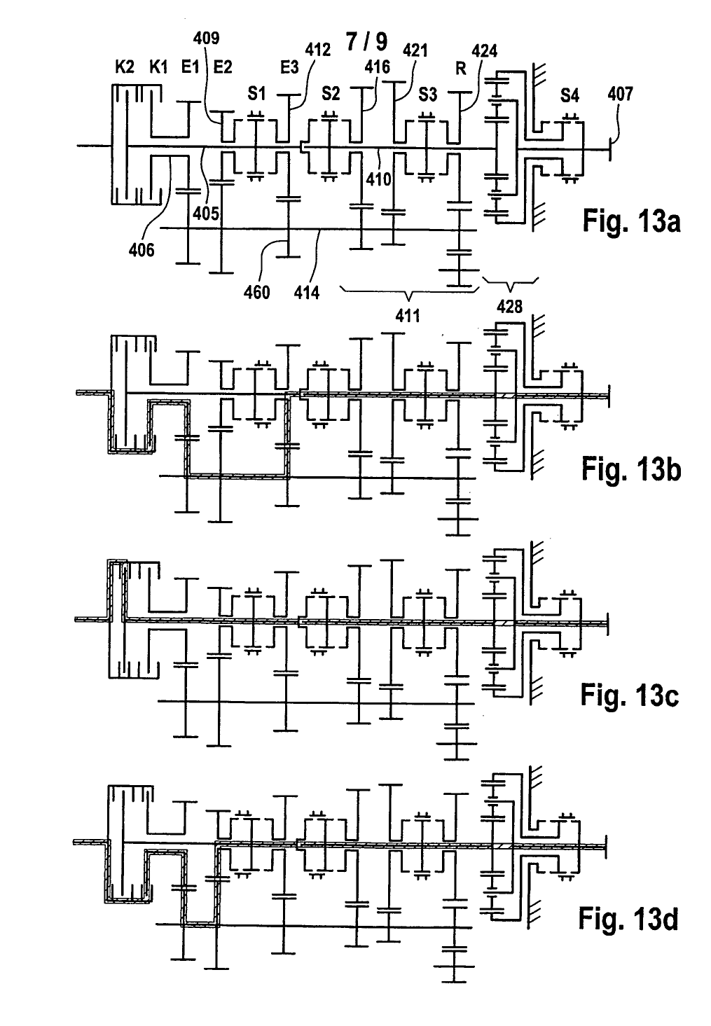

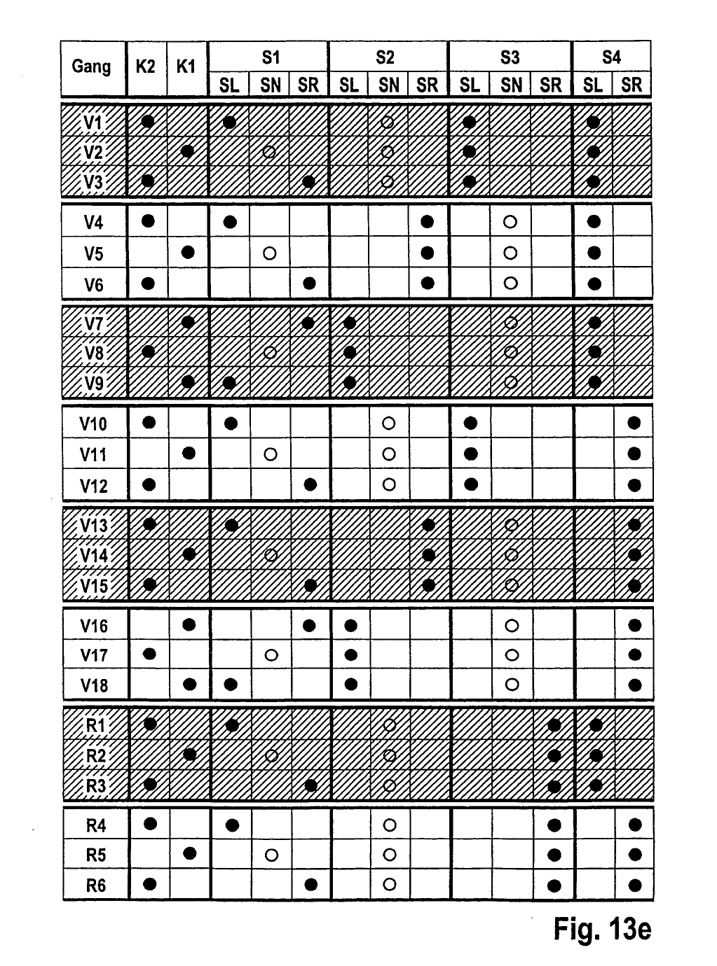

FIGS. 13a to 13d show a load shift transmission in which the front-most gearwheel plane of the main transmission of a load-shift transmission according to FIGS. 1 to 7 has been replaced by a third constant. As a result, one shift element less than a load shift transmission according to FIGS. 1 to 7 is required. This is due to the fact that in the load shift transmission with three input constants E1 to E3 all the shift elements S1 to S3 can be configured so as to be effective or displaceable in both directions, as is the case in the load shift transmission according to FIG. 13a. Consequently, in the text which follows the differences from the load shift transmission according to FIG. 1 are specified. The third input constant E3 comprises a freely moving wheel 412 which is mounted in a coaxially rotatable fashion on the intermediate shaft 405 which is embodied as an internal shaft. The third input constant E3 also comprises a fixed wheel 460 which is arranged in a rotatably fixed fashion on the countershaft 414 and meshes with this freely moving wheel 412. A first shift element S1 which is effective on both sides is arranged axially between this freely moving wheel 412 and a freely moving wheel 409 of the second input constant E2, which shift element S1 can establish a rotationally fixed connection between the intermediate shaft 405 and one of the two freely moving wheels 412 or 409. In this context, when a corresponding shift sleeve of the shift element S1 is displaced forward, a rotationally fixed connection to the freely moving wheel 409 is established, while, in the event of a displacement to the rear, a rotationally fixed connection to the freely moving wheel 412 is established. Behind this freely moving wheel 412 of the third input constant E3 there is a pilot bearing of the main shaft 410 with respect to the aforesaid intermediate shaft 405. In this region or directly behind it a second shift element S2 is arranged, which shift element S2 is capable of establishing a rotationally fixed connection between the main shaft 410 and the intermediate shaft 405. In addition, with this second shift element S2 it is possible to establish a rotationally fixed connection between the main shaft 410 and one 416 of the freely moving wheels of the first gearwheel plane of the main transmission 411. The third shift element S3 is arranged axially between a freely moving wheel 421 of the second gearwheel plane of the main transmission 411 and a freely moving wheel 424 of the reverse gear R. With this third shift element S3 it is thus possible to connect the main shaft 410 alternatively to one of the two last-mentioned freely moving wheels 421, 424 in a rotationally fixed fashion.

In FIG. 13a, the first three shift elements S1 to S3 are shown in a central neutral position, while a range group 428 which is embodied as a planetary gear mechanism is shifted as a rotating block with a fourth shift element S4.

FIG. 13b illustrates the load shift transmission when the sixteenth forward gear V16 is engaged. In this case, the shift sleeve of the first shift element S1 is displaced to the rear, while the shift sleeve of the second shift element S2 is displaced to the front, and the shift sleeve of the third shift element S3 is in the neutral position. As a resuit, the first input constant E1 and the third input constant E3 are in the power path which extends from the first individual clutch K1 to the transmission output flange 407 via an intermediate shaft 406 which is embodied as a hollow shaft, the first input constant E1, the countershaft 414, the third input constant E3, the main shaft 410 and the range group 428 which rotates as a block.

FIG. 13c shows the load shift transmission when the seventeenth forward gear V17 is engaged. The seventeenth forward gear V17 is the direct gear here, in which case the power path extends via the second individual clutch K2, with the result that the gear change from the sixteenth forward gear V16 takes place by means of an overlapping control operation without interruption in the tractive force. The shift sleeve of the second shift element S2 is located here in the front position, with the result that the intermediate shaft 405 and the main shaft 410 are coupled to one another in a rotationally fixed fashion. The shift sleeves of the first shift element S1 and of the third shift element S3 are in the neutral position.

FIG. 13d represents the load shift transmission when the eighteenth forward gear V18 is engaged. In this case, the shift sleeves of the first two shift elements S1 and S2 are displaced to the front, while the shift sleeve of the third shift element S3 is in the neutral position. The first input constant E1 and the second input constant E2 are in the power path which extends from the first individual clutch K1 to the transmission output flange 407 via the intermediate shaft 406 which is embodied as a hollow shaft, the first input constant E1, the countershaft 414, the second input constant E2, the intermediate shaft 405, the main shaft 410 and the range group 428 which rotates as a block.

The shifted states which are represented in the table of FIG. 13e therefore are present at this load shift transmission. The load shift transmission with three input constants with different transmission ratios from one another can then be embodied as an 18 gear transmission with an overdrive gear. In this context, the forward gears V1 to V18 are illustrated in succession in the rows. Following the latter, the six reverse gears R1 to R6 are illustrated in the rows. The non-hatched and the hatched rows have an analogous meaning to the preceding exemplary embodiments. In this context, in each case load shifting can be performed sequentially on three successive gears so that a gear speed change which cannot be load shifted is followed again by three gears with which load shifting can be performed sequentially. The shifted states of the second individual clutch K2, of the first individual clutch K1, of the first shift element S1, of the second shift element S2, of the third shift element S3 and of the fourth shift element S4 are illustrated following one another in the columns. What position each of the shift elements S1 to S4 has engaged in which gear is illustrated in separate columns, from which the number of possible positions per shift element also becomes apparent. In this context, the first three shift elements S1 to S3 are assigned in each case three positions SL, SN, SR, in which case SN represents the central, neutral, position and the two positions SL, SR bring about the rotationally fixed coupling to, in each case, one freely moving wheel which is assigned to one of two input constants.

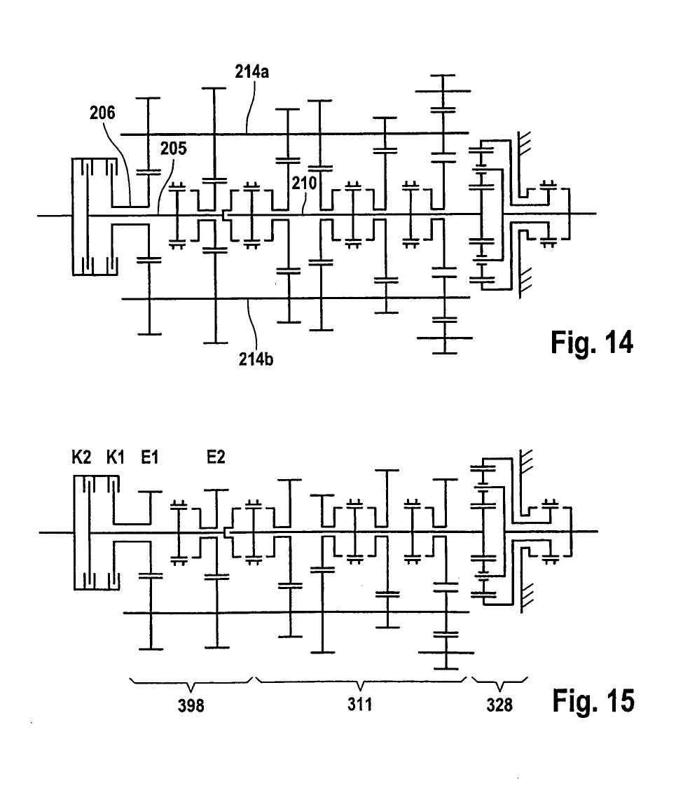

FIG. 14 shows a load shift transmission with two countershafts which are associated with the same component transmission and both are provided exclusively with fixed wheels. The two countershafts 214a, 214b can be arranged, for example, in a plane with the main shaft 210 so that the effect of the toothing forces is cancelled out and the hollow shaft 206, the internal shaft 205 and the main shaft 210 do not bend. Otherwise, the load shift transmission corresponds to the exemplary embodiment according to FIGS. 1 to 7. In an alternative embodiment relating to FIG. 14 it is also possible for the two countershafts not to be located in one plane with the main shaft so that the effect of the toothing forces is only partially compensated. This small disadvantage in terms of bearing load can have advantages in terms of construction space.

FIG. 15 shows a load shift transmission which is embodied as a 16 gear transmission with two overdrive gears. Compared to the exemplary embodiment according to FIGS. 1 to 7, the transmission ratio of the second input constant E2 is considerably smaller, with the result that the second input constant gears up. As a result, the transmission housing and the bearings can be made smaller since the high rotational speed is accompanied by a smaller torque. In this context, the load shift transmission according to FIG. 15 is also divided into a split group 398, a main group 311 and a range group 328.

In the first exemplary embodiment, it is illustrated in FIGS. 5 and 6 that the next highest forward gear with respect to the direct gear in the power path transmits power via the two input constants E1 and E2, in which case a load shifting capability is provided between the direct gear and the aforesaid forward gear. In an alternative embodiment, the transmission ratio of the two input constants can be configured in such a way that in the next lowest forward gear with respect to the direct gear in the power path power is transmitted via the two input constants. In both alternatives, the load shifting capability is present both for shifting up and for shifting down.

An alternative embodiment of the shift diagrams of the load shift transmissions according to FIGS. 8, 10 and 12 is possible and it is illustrated in the region of the reverse gears by means of square brackets. If a gear, in which the power path extends via K1 and K2 is opened, is shifted, the first shift element S1 which is already engaged in order to prepare the next gear change can alternatively also be placed in the neutral position SN. This is illustrated graphically in FIGS. 8 and 10 for the second reverse gear R2 and the fourth reverse gear R4. However, what has been said previously also applies to the other gears in which the power path extends via K1 and K2 is opened. The situation for the second reverse gear R2 in FIG. 12 is analogous.

The described embodiments are only exemplary embodiments. A combination of the described features for different embodiments is also possible. Further features, in particular ones which have not been described, of the parts of the device which are associated with the invention can be found in the geometries of the parts of the device which are illustrated in the drawings.

What is claimed is:

1. An automated load-shift transmission comprising an input shaft (34), a twin clutch (1) connected to the input shaft (34), a transmission output shaft (29) coaxially supported with the twin clutch (1), a countershaft (14) extending in parallel spaced relationship with the axis of the twin clutch (1) and the output shaft (34), the transmission including a plurality of freely rotatable gears and shift elements for engaging the rotatable gears, all disposed along the axis of the twin clutch (1) and the output shaft (29) and a plurality of fixed gears all disposed on the countershaft (14).

2. The automated load-shift transmission as claimed in claim 1, wherein the transmission includes a split-group (98) with two input constants (E1, E2) of different trans-mission ratios and a main group (11) including at least two gear wheel stages (15, 16, 17, 22) of which one forms a reverse gear (22).

3. The automatic load shift transmission as claimed in claim 2, wherein load shifting can be performed in connection with gear changes in which the power path changes by means of an overlap control on the double clutch (1) from one of the input constants (E1 or E2) to the other input constant (E2 or E1) and extends via a gearwheel stage (15, 16, 17, 22), without modification in the main transmission group (11).

4. The automatic load shift transmission as claimed in claim 3, wherein the transmission has a direct gear (V15) two input constants (E1, E2) and at least one of the next higher and lower forward gears (V16, V14) above and, respectively, below the direct gear (V15) extends via the two input constants (E1, E2) in the power path.

5. The automatic load shift transmission as claimed in claim 4, wherein a load shifting capability is provided between the direct gear (V15) and the adjacent forward gear (V16, V14) which extends via the two input constants (E1 and E2).

6. The automatic load shift transmission as claimed in claim 1, wherein the load shift transmission has a shift diagram with a gear group of adjacent forward gears (V13 to V16) whose number is higher than the number of input constants (E1 and E2), wherein these forward gears are shiftable sequentially without interruptions of the tractive force in both shifting directions, and one of these gears of the direct gear (V15) is arranged, in the shifting sequence, between the forward gears (V13, V16) which delimits the gear group.

7. The automatic load shift transmission as claimed in patent claim 6, wherein the main group (11) is followed by a range group (28), wherein the load shifting capability of the aforesaid four forward gears (V13 to V16) which follow one another sequentially is used exclusively in one shifted state (SL) of at least two shifted states (SL, SR) of the range group (28).

8. The automatic load shift transmission as claimed in claim 6, wherein the gear group comprises a gear whose power path extends via the two input constants (E1 and E2).

9. The automatic load shift transmission as claimed in claim 1, wherein at least one crawler gearwheel stage (C), is provided in the main transmission (111) and a controller for automating the load shift transmission is also provided which, however, cannot shift said crawler gearwheel stage (C) in all shifted states (SL, SR) of the range group (128).

10. The automatic load shift transmission as claimed in claim 1, wherein all the shift elements (S1, S2, S3, S4, S5) are arranged coaxially with respect to the twin clutch (1) at the transmission input side and the countershaft (14) carries exclusively fixed wheels (15, 18, 19, 25).

11. The automatic load shift transmission as claimed in claim 2, wherein one (E1) of the input constants (E1, E2) is embodied as a fixed wheel (8), while at least one other input constant (E2) is embodied as a freely moving wheel (9) engageable by a shift element (S1).

12. The automatic load shift transmission as claimed in claim 4, wherein with the direct gear (V15) engaged, the countershaft (14) can be decoupled rotationally from the rotational movement of the transmission input and output shafts.

13. The automatic load shift transmission as claimed in claim 12, wherein the countershaft (14) is decoupled in the direct gear by means of the individual clutch (K1) which is connected to an input gearwheel (8) of the input constant (E1).

14. The automatic load shift transmission as claimed in claim 1, wherein the load shift transmission has a plurality of gear groups of in each case three successive forward gears (V7, V8, V9), wherein the load shifting can be performed sequentially in any desired direction on the three forward gears (V7, V8, V9) of each of these gear groups, wherein the highest and the lowest of these three forward gears (V7, V8, V9) each have adjacent to them a forward gear (V6, V10) on which load shifting cannot be performed from the aforesaid highest or lowest forward gear (V7 or V10, respectively).

15. The automatic load shift transmission as claimed in claim 1, wherein the load shift transmission has at least three reverse gears between which sequential load shifts can be performed in any desired direction.

16. The automatic load shift transmission as claimed in claim 1, wherein three input constants (E1 to E3) are provided, one input constant (E1) of which is assigned to the one individual clutch (K1), while the other two input constants (E2 and E3) are assigned to the other individual clutch (K2), wherein a shift element (S1) is arranged between the two last-mentioned input constants (E2 and E3) in such a way that each of the two input constants (E2 and E3) can alternately be coupled in a rotationally fixed fashion to the other individual clutch (K2).

17. The automatic load shift transmission as claimed in patent claim 16, wherein a second shift element (S2) is provided with which a main shaft (410) of a main transmission (411) can be coupled to either one of
an intermediate shaft (405) which is connected to the other individual clutch (K2) in an essentially rotationally fixed fashion and
a freely moving wheel (412) of a gearwheel stage of a main transmission (411).

18. The automatic load shift transmission as claimed in claim 15, wherein a plurality of transmission ratio states come about as a result of the combinatorial switching of transmission ratios of the split group (E1 and E2, and E1 and E3, respectively), and in that at least one of these aforesaid transmission ratios is located below the direct gear in terms of transmission ratio, and a further of these aforesaid transmission ratios is located above the direct gear in terms of transmission ratio, and it is possible to shift sequentially in any desired direction without an interruption in tractive force between the aforesaid three gears which have come about as a result of the combinatorial switching of transmission ratios of the split group (E1 and E2, and E1 and E3, respectively) and the direct gear.

19. The automatic load shift transmission as claimed in claim 1, wherein at least two countershafts are provided and with a gear is engaged be a shift element, the drive power is transmitted divided between at least two countershafts (214a, 214b).
